(19) United States
(12) Patent Application Publication
(10) Pub. No.: US 2009/0096782 A1
(43) Pub. Date: Apr. 16, 2009

(54) MESSAGE SERVICE METHOD SUPPORTING THREE-DIMENSIONAL IMAGE ON MOBILE PHONE, AND MOBILE PHONE THEREFOR

(75) Inventor: Sang-Hyun LEE, Anyang-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 12/207,118

(22) Filed: Sep. 9, 2008

(30) Foreign Application Priority Data
Oct. 12, 2007 (KR) 2007-0102981

(51) Int. Cl. G06T 15/00

(52) U.S. Cl. 345/419

(57) ABSTRACT

A message service method supporting a three-dimensional (3D) image on a mobile phone, and a mobile phone therefor, are provided. A memory stores at least one 3D image code and a 3D image mapped to each 3D image code. When a text-based message is created, a controller inserts a 3D image code mapped to a 3D image selected by a user into the text-based message and sends the message. When the 3D image is dynamically displayed along with text of the message, a sender can better express his or her emotions. A 3D moving image is a more effective means of expression than a still image or text.

### PRIORITY

This application claims priority under 35 U.S.C. §119(a) from to a Korean Patent Application entitled “MESSAGE SERVICE METHOD SUPPORTING THREE-DIMENSIONAL IMAGE ON MOBILE PHONE, AND MOBILE PHONE THEREFOR” filed in the Korean Intellectual Property Office on Oct. 12, 2007 and assigned Serial No. 2007-0102981, the entire contents of which are incorporated herein by reference.

### BACKGROUND OF THE INVENTION

1. Field of the Invention

The present invention relates to a message service method supporting a three-dimensional (3D) image to better express a sender's emotions in a message between mobile phones, and a mobile phone therefor.

2. Description of the Related Art

Conventional mobile phones generally support a text-based Short Message Service (SMS), which is cheaper than a voice communication service and a Multimedia Message Service (MMS) capable of attaching a video, a still image, a music file, etc., to text.

In conventional message services, a sender may use special characters or emoticons in order to express his or her emotions through a message. However, since available characters or emoticons have limitations in expressing human emotions, it is difficult to sufficiently express emotions like happiness, anger, sadness, fear, etc. through the message.

In the conventional message services, a method for attaching several images or photos is also provided, but the sender's emotions may not be sufficiently expressed since it is impossible to express his or her actions or motions in still images or photos.

To better express the sender's emotions, a method for attaching a captured moving image to a multimedia message or employing a video phone is available, but a file size is limited by network limitations of a communication provider and the service is expensive.

The need exists for a technology for cost-effectively providing a message including various expressions and emotions of a sender through a mobile phone.

### SUMMARY OF THE INVENTION

The present invention provides a message service method supporting a 3D image on a mobile phone that can create a message including an identification code for displaying a 3D image for user-desired expressions, and a mobile phone therefor.

The present invention also provides a message service method supporting a 3D image on a mobile phone that can display both a 3D image mapped to an identification code inserted into a received message and text inserted into the message, and a mobile phone therefor.

According to an aspect of the present invention, there is provided a mobile phone for displaying a 3D image, including a memory that stores at least one 3D image code and a 3D image mapped to each 3D image code; and a controller that inserts a 3D image code mapped to a 3D image selected by a user into a text-based message when the text-based message is created, and sends the message.

The 3D image code stored in the memory may include at least one of 3D face, body, and background codes.

The 3D image code may include at least one of a character string and an emoticon.

The message may be at least one of a short message and a multimedia message.

The controller may include a code acquirer that acquires a 3D image code mapped to a selected 3D image when the at least one stored 3D image is displayed; and a message creator that creates the text-based message, inserts the 3D image code acquired by the code acquirer into the created message, and sends the message.

The code acquirer may acquire the 3D image code mapped to the selected 3D image from a preset external server when a plurality of 3D images downloaded from the server is displayed.

The message creator may send the created message by performing at least one of an operation for inserting the acquired 3D image code into text of the created message and an operation for setting the acquired 3D image code in a specific message field.

The controller may send the message into which at least one of an emoticon and text input by the user is inserted as a 3D image code.

The controller may include a determiner that determines whether a 3D image code is inserted into a message received from an external transmission; a code extractor that extracts the 3D image code inserted into the message when the determiner determines that the 3D image code is inserted into the message; and a message display that displays a read 3D image and message content by reading the 3D image mapped to the 3D image code extracted by the code extractor.

The message display may display the downloaded image and the message content by downloading the 3D image mapped to the 3D image code from a preset external server.

According to another aspect of the present invention, there is provided a message service method supporting a 3D image on a mobile phone, including acquiring a 3D image code; creating a text-based message; inserting the acquired 3D image code into the created message; and sending the message.

The acquiring step may include displaying at least one 3D image on a screen; and acquiring a 3D image code mapped to a selected 3D image from a memory when the 3D image is selected from the screen.

The acquiring step may include downloading at least one 3D image code and a 3D image mapped to each 3D image code from a preset external server.

The acquiring step may include receiving a text-based 3D image code from a user.

The message may be at least one of a short message and a multimedia message.

The sending step may include inserting the acquired 3D image code into content of the created message and sending the message.

The sending step may include sending the created message by performing at least one of an operation for inserting the acquired 3D image code into the created message and an operation for setting the acquired 3D image code in a specific message field.

According to still another aspect of the present invention, there is provided a message service method supporting a 3D image on a mobile phone, including determining whether a 3D image code is inserted into a message received from an external transmission; reading a 3D image mapped to the inserted 3D image code upon determining that the 3D image code is inserted; and displaying the read 3D image and message content.

The message may be at least one of a short message and a multimedia message.

The reading step may include downloading and reading the 3D image mapped to the 3D image code from a preset external server.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate like components, wherein:

FIG. 1 is a schematic block diagram of a mobile phone for performing a message service method according to an exemplary embodiment of the present invention;

FIGS. 2A and 2B are schematic block diagrams of a controller illustrated in FIG. 1;

FIGS. 3 to 6 illustrate exemplary screens of the mobile phone illustrated in FIG. 1;

FIGS. 7 and 8 are flowcharts illustrating an operation of the controller illustrated in FIG. 1; and

FIG. 9 is a flowchart illustrating an operation of a mobile phone according to another exemplary embodiment of the present invention.

### DETAILED DESCRIPTION OF EXEMPLARY EMBODIMENTS

Exemplary embodiments of the present invention will be described in detail below with reference to the accompanying drawings.

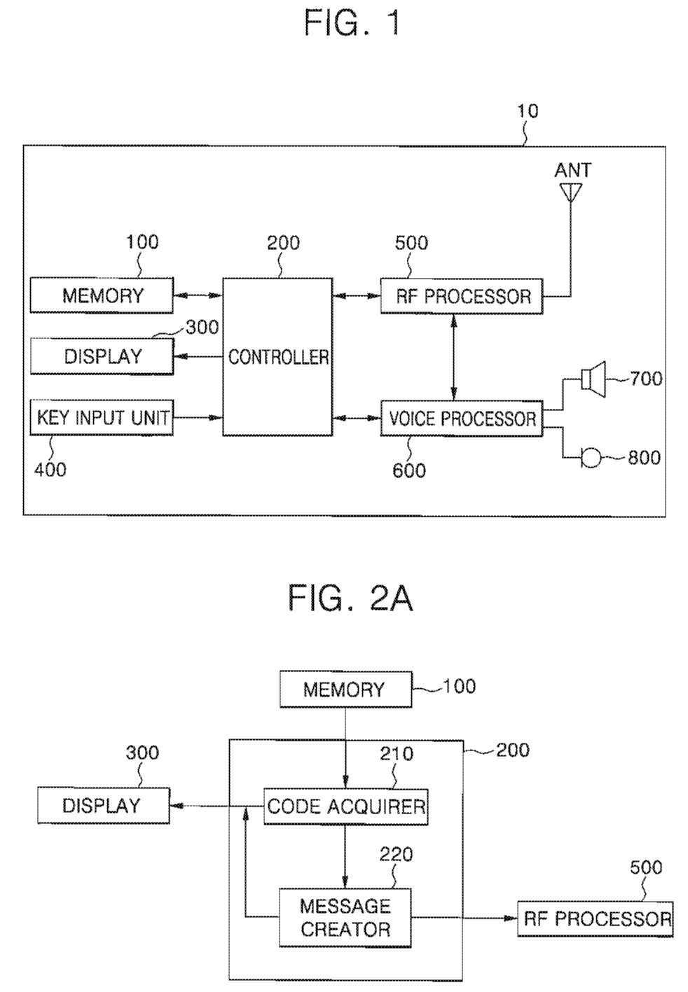

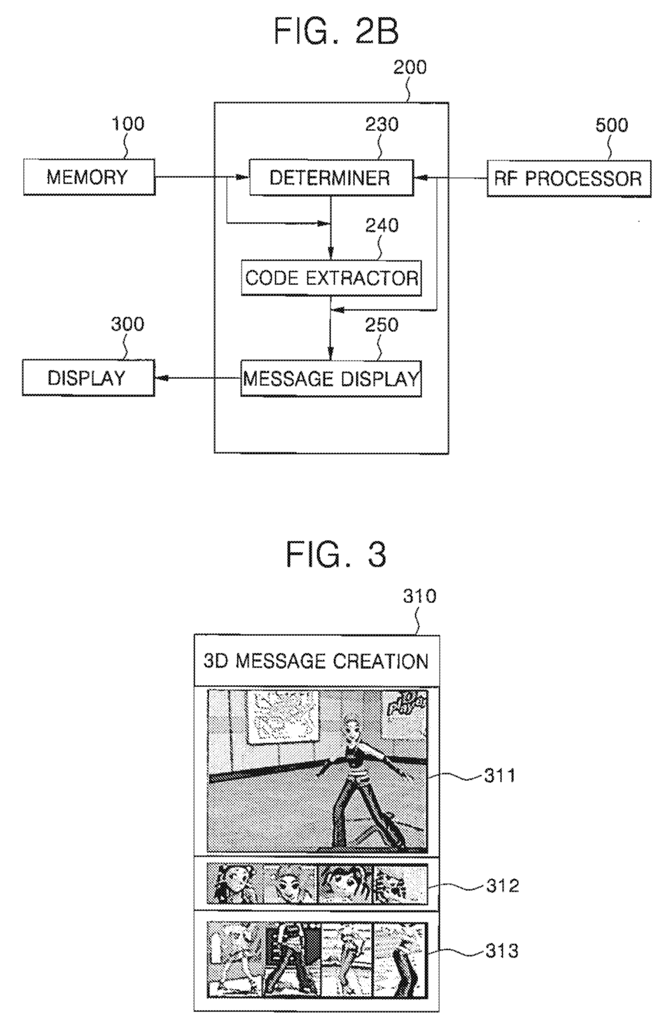

FIG. 1 is a schematic block diagram of a mobile phone for performing a message service method according to an exemplary embodiment of the present invention, and FIGS. 2A and 2B are schematic block diagrams of a controller provided on the mobile phone illustrated in FIG. 1.

Referring to FIG. 1, a mobile phone 10 includes a memory 100 for storing at least one 3D image code and at least one 3D image, a controller 200 for performing the message service method according to the exemplary embodiment of the present invention, a display 300 for providing a screen, a key input unit 400 for providing buttons, a Radio Frequency (RF) processor 500, a voice processor 600, a speaker 700, and a microphone 800.

The memory 100 stores at least one 3D image code and a 3D image mapped to each 3D image code.

The 3D image code includes a 3D face code mapped to a face and a 3D body code mapped to a body as in a 3D avatar, but the present invention is not limited thereto. Alternatively, a single type of 3D image code may be implemented, or a 3D background code mapped to a background may be further included.

According to an exemplary embodiment of the present invention, the 3D image code can be configured with information having a preset identifier (for example, a character string X001 including X at the beginning of the 3D face code, a character string Y001 including Y at the beginning of the 3D body code, etc.), but the present invention is not limited thereto. Alternatively, the 3D image code may be configured with a preset emoticon or a character string input by the user.

According to an exemplary embodiment of the present invention, the controller 200 acquires the 3D image codes (3D face and body codes), inserts the 3D image codes into a message, and sends the message.

As illustrated in FIG. 2A, the controller 200 includes a code acquirer 210 for, when 3D images are provided, acquiring a 3D image code mapped to an image selected by the user and a message creator 220 for creating a text message including the acquired 3D image code.

According to an exemplary embodiment of the present invention, when the 3D image code is identified from a text message received from an external transmission, the controller 200 displays both a 3D image mapped to a corresponding 3D image code and content of a text message.

As illustrated in FIG. 2B the controller 200 includes a determiner 230 for determining whether a 3D image code is inserted into a received text message, a code extractor 240 for extracting the 3D image code from the text message, and a message display 250 for displaying a 3D image and content of the text message.

As illustrated in FIG. 2A, the code acquirer 210 acquires a 3D image code mapped to a 3D image selected by the user when 3D images stored in the memory 100 are displayed, but the present invention is not limited thereto. Alternatively, the code acquirer 210 may access a preset external server (for example, an avatar provider server, etc.) and acquire a 3D image code mapped to a 3D image selected by the user from among 3D images provided from the server.

According to an exemplary embodiment of the present invention, when a screen window 310 (illustrated in FIG. 3) for separately selecting 3D face and body images is provided, the code acquirer 210 acquires 3D image codes (3D face and body codes) mapped to selected 3D images.

As illustrated in FIG. 3, the screen window 310 is configured to include a main screen 311 for combining and displaying the selected 3D images, a face selection screen 312 for displaying 3D face images, and a body selection screen 313 for displaying 3D body images, but the present invention is not limited thereto.

When the user selects the 3D images using the face selection screen 312 and the body selection screen 313, the code acquirer 210 acquires the 3D image codes (3D face and body codes) mapped to the selected 3D images and combines and displays the selected 3D images on the main screen 311.

The message creator 220 creates a text-based message through a well-known text message creation method, inserts the 3D image codes (3D face and body codes) acquired by the code acquirer 210 into the message, and sends the message.

The message creator 220 creates a text-based short message according to the exemplary embodiment of the present invention, but may create a multimedia message to which a file can be attached.

Accordingly, the message creator 220 can be configured to insert the acquired 3D image codes into message content, set the acquired 3D images codes in a specific message field, or attach the acquired 3D image codes to a separate file of a multimedia message.

However, as illustrated in FIG. 2B, when the text message is received from an external transmission, the determiner 230 determines whether there are 3D image codes inserted into a received text message.

When the determiner 230 determines that there are 3D image codes inserted into the text message, the code extractor 240 parses the text message and then extracts the 3D image codes inserted into the text message.

The message display 250 reads one or more 3D images mapped to the 3D image codes (3D face and body codes) extracted by the code extractor 240, and displays the read 3D image and message content.

The message display 250 displays the 3D image and the message content after downloading the 3D image mapped to the corresponding 3D image codes from the preset external server.

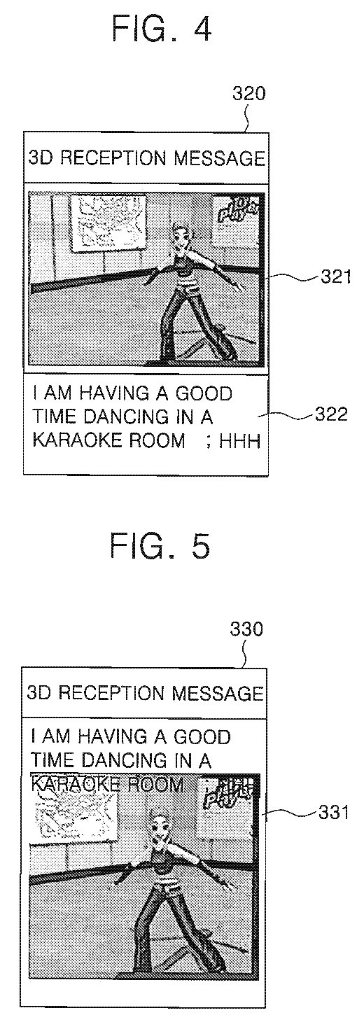

As illustrated in FIG. 4, the message display 250 provides a screen window 320 including a screen 321 for displaying a 3D image and a screen 322 for displaying message content in order to separately display the 3D image and the message content, but the present invention is not limited thereto.

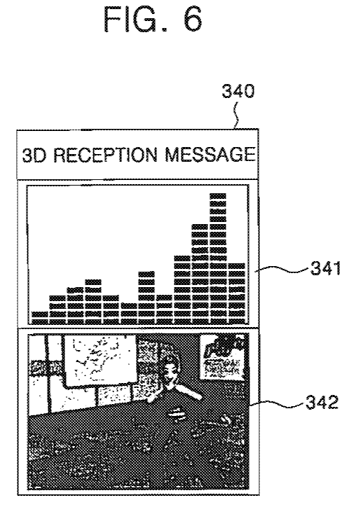

For example, the message display 250 can display both a 3D image and text in a single-screen window 330, as illustrated in FIG. 5. Alternatively, the message display 250 can display the 3D image, text, and the reproduction of an audio file of a multimedia message on an additional screen, as illustrated in FIG. 6.

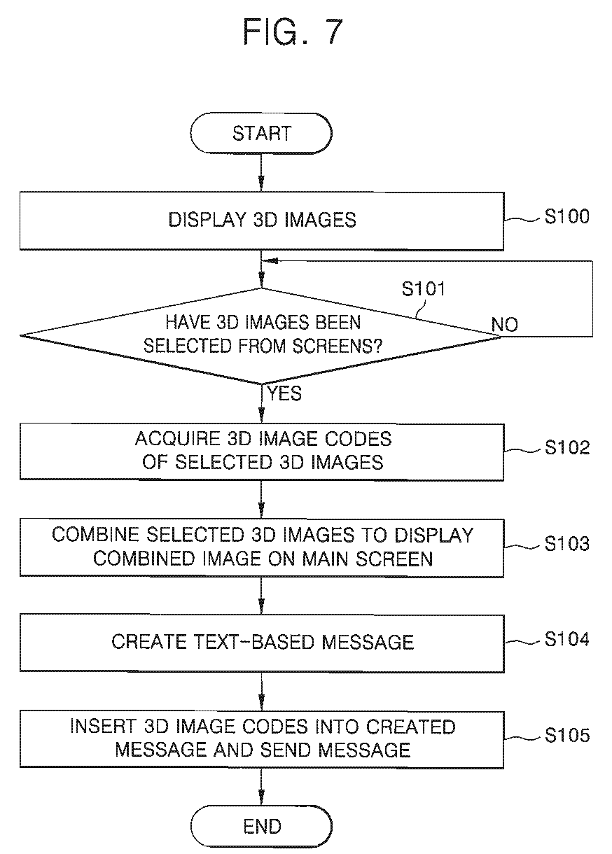

FIG. 7 is a flowchart illustrating an operation for processing and sending a message including 3D image codes on the mobile phone.

Referring to FIG. 7, the code acquirer 210 displays a plurality of 3D images on the screen window 310, in step S100.

The code acquirer 210 determines whether 3D images have been selected from the face selection screen 312 and the body selection screen 313 of the screen window 310, in step S101. When 3D images have been selected, the code acquirer 210 acquires 3D image codes (3D face and body codes) mapped to the selected 3D images from the memory 100, in step S102.

The code acquirer 210 displays a combined 3D image on the main screen 311 of the screen window 310 by combining the acquired 3D images, in step S103.

The message creator 220 creates a text-based message according to key data input from the key input unit 400, in step S104.

The message creator 220 inserts the acquired 3D image codes of step S103 into the created message of step S104 and sends the message, in step S105.

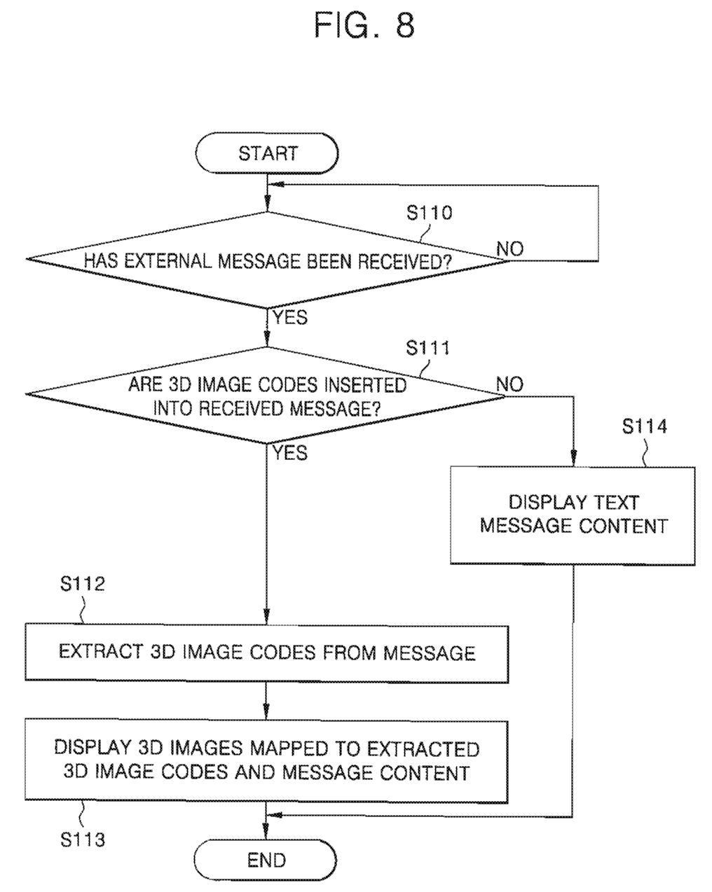

FIG. 8 is a flowchart illustrating an operation for receiving and processing a message including 3D image codes on the mobile phone.

Referring to FIG. 8, the controller 200 determines whether a text message has been received from an external transmission, in step S110.

Upon determining that the text message has been received in step S110, the determiner 230 determines whether there are 3D image codes inserted into the received message, in step S111.

Upon determining that there are 3D image codes inserted into the received message in step S111, the code extractor 240 extracts the 3D image codes from the message, in step S112.

The message display 250 combines 3D images mapped to the extracted 3D image codes of step S112 and displays both a combined 3D image and message content, in step S113.

Upon determining that there are no 3D image codes in the message in step S111, the message display 250 displays the content of the message, in step S114.

However, when a multimedia message is used according to another exemplary embodiment of the present invention, the mobile phone reproduce an attached multimedia file and display a 3D image.

For this usage of a multimedia message, the message creator 220 not only can send the message content and the 3D image codes acquired by the code acquirer 210, but also can attach and send the multimedia file selected by the user.

As illustrated in FIG. 6, the message display 250 provides a screen window 340 including a screen 341 for displaying the reproduction of a multimedia file and a screen 342 for displaying message content and a 3D image.

Accordingly, the message display 250 displays a 3D image according to the 3D image codes extracted by the code extractor 240 and content of a received message on the screen 342 and displays reproduction information on the screen 341 by downloading and reproducing an attached multimedia file.

The above-described mobile phone operates as follows.

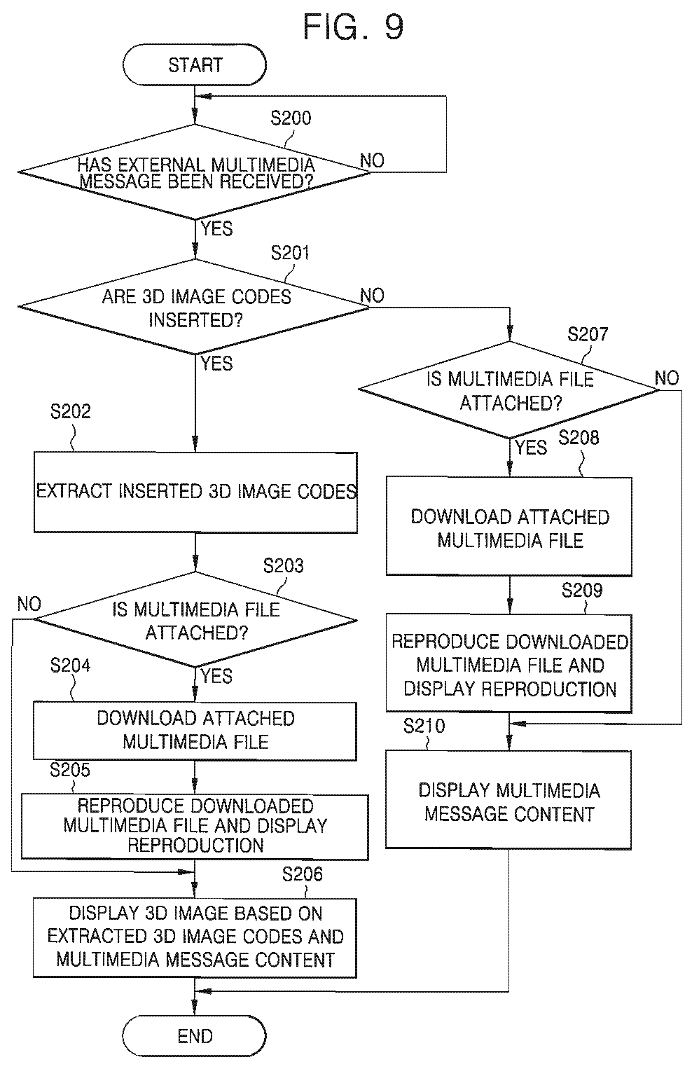

Referring to FIG. 9, the controller 200 determines whether a multimedia message has been received from an external transmission, in step S200.

Upon determining that a multimedia message has been received in step S200, the determiner 230 determines whether there are 3D image codes inserted into the received message, in step S201.

Upon determining that there are 3D image codes inserted into the received message in step S201, the code extractor 240 extracts the 3D image codes from the multimedia message, in step S202.

The message display 250 determines whether a multimedia file is attached to the multimedia message, in step S203, and downloads the attached multimedia file, in step S204.

The message display 250 displays the reproduction of the downloaded multimedia file of step S204 on the screen 341, in step S205.

The message display 250 displays a 3D image according to the extracted 3D image codes of step S202 and multimedia message content on the screen 342, in step S206.

Upon determining that there are no 3D image codes inserted into the corresponding multimedia message in step S201, the message display 250 determines whether a multimedia file is attached to the corresponding multimedia message such that the message is received and displayed as in the well-known multimedia message processing method, in step S207, and downloads the attached multimedia file, in step S208.

The message display 250 displays the reproduction of the downloaded multimedia file of step S208, in step S209, and displays the multimedia message content, in step S210.

Accordingly, when the multimedia file attached by a sender is reproduced, a receiver can view a 3D image simultaneously.

However, when a message including the 3D image codes is received according to another exemplary embodiment of the present invention, the mobile phone can separately store a 3D image by combining 3D images mapped to 3D image codes.

The message display 250 displays both a stored 3D image and message content after separately storing the 3D image by combining the 3D images mapped to 3D image codes (3D face and body codes) extracted by the code extractor 240.

Accordingly, the receiver can use a stored 3D image in another program (for example, a background screen, etc.) by separately storing the 3D image mapped to the 3D image codes sent by the sender.

The mobile phone can use 3D image codes implemented with a text-based character string or emoticons according to another embodiment of the present invention.

The memory 100 can store at least one preset emoticon (or character string) and a 3D image mapped to each emoticon.

Accordingly, the user directly creates a character string or emoticon mapped to a 3D image, thereby quickly processing 3D images stored in the memory 100 without loading and selecting the images on a screen one by one.

According to exemplary embodiments of the present invention, a 3D moving image (expressing the action of running while standing still or crying while covering a face with the hands, which goes beyond mere facial expressions) can be displayed using a text message, thereby allowing a message sender to better express his or her emotions by extending the range of possible expressions.

For example, the sender can optionally express a special action (for example, the action of dancing with smile or crying while sitting) through the message, such that his or her emotions can be expressed in a 3D moving image.

Since a 3D image does not need to be directly attached, the present invention addresses the problem of the limited file size of a text message by employing a 3D image code necessary to transfer the 3D image.

The present invention can send a 3D image and a multimedia file using a multimedia message. For example, a message receiver can learn dance from a message sender while viewing a 3D image of dancing to music.

Although exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A mobile phone for displaying a three-dimensional (3D) image, comprising:
a memory for storing at least one 3D image code and a 3D image mapped to each 3D image code; and
a controller for, when a text-based message is created, inserting a 3D image code mapped to a 3D image selected by a user into the text-based message, and sending the message.

2. The mobile phone of claim 1, wherein the 3D image code stored in the memory includes at least one of a 3D face code, a body code, and a background code.

3. The mobile phone of claim 1, wherein the 3D image code includes at least one of a character string and an emoticon.

4. The mobile phone of claim 1, wherein the message is at least one of a short message and a multimedia message.

5. The mobile phone of claim 1, wherein the controller includes:
a code acquirer for, when the at least one stored 3D image is displayed, acquiring a 3D image code mapped to a selected 3D image; and
a message creator for creating the text-based message, inserting the 3D image code acquired by the code acquirer into the created message, and sending the message.

6. The mobile phone of claim 5, wherein, when a plurality of 3D images downloaded from the server are displayed, the code acquirer acquires the 3D image code mapped to the selected 3D image from a preset external server.

7. The mobile phone of claim 5, wherein the message creator sends the created message by performing at least one of an operation for inserting the acquired 3D image code into text of the created message and an operation for setting the acquired 3D image code in a specific message field.

8. The mobile phone of claim 3, wherein the controller sends the message into which at least one of an emoticon and text input by the user is inserted into the 3D image code.

9. A mobile phone for displaying a 3D image, comprising:
a determiner for determining whether a 3D image code is inserted into a message received from an external transmission;
a code extractor for, when the determiner determines that the 3D image code is inserted into the message, extracting the 3D image code inserted into the message; and
a message display for displaying a read 3D image and message content by reading the 3D image mapped to the 3D image code extracted by the code extractor.

10. The mobile phone of claim 9, wherein the message display displays the downloaded image and the message content by downloading the 3D image mapped to the 3D image code from a preset external server.

11. A message service method supporting a 3D image on a mobile phone, comprising the steps of:
acquiring a 3D image code;
creating a text-based message;
inserting the acquired 3D image code into the created message; and
sending the message.

12. The message service method of claim 11, wherein the acquiring step includes:
displaying at least one 3D image on a screen; and
when the 3D image is selected from the screen, acquiring a 3D image code mapped to a selected 3D image from a memory.

13. The message service method of claim 11, wherein acquiring the 3D image includes:
downloading at least one 3D image code and a 3D image mapped to each 3D image code from a preset external server.

14. The message service method of claim 11, wherein acquiring the 3D image includes:
receiving a text-based 3D image code from a user.

15. The message service method of claim 11, wherein the message is at least one of a short message and a multimedia message.

16. The message service method of claim 11, wherein sending the message includes:
inserting the acquired 3D image code into content of the created message and sending the message.

17. The message service method of claim 11, wherein sending the message includes:
sending the created message by performing at least one of an operation for inserting the acquired 3D image code into the created message and an operation for setting the acquired 3D image code in a specific message field.

18. A message service method supporting a 3D image on a mobile phone, comprising the steps of:
determining whether a 3D image code is inserted into a message received from an external transmission;
upon determining that the 3D image code is inserted, reading a 3D image mapped to the inserted 3D image code; and
displaying the read 3D image and message content.

19. The message service method of claim 18, wherein the message is at least one of a short message and a multimedia message.

20. The message service method of claim 18, wherein reading the 3D image includes:
downloading and reading the 3D image mapped to the 3D image code from a preset external server.
